(19) United States
(12) Patent Application Publication
(10) Pub. No.: US 2013/0092096 A1
(43) Pub. Date: Apr. 18, 2013

(54) Apparatus for Foldable Treadmill for Pets

(71) Applicant: DOG PACER LLC, Las Vegas, NV (US)

(72) Inventors: Yaniv Rosenberg, Las Vegas, NV (US); David Ezra, Las Vegas, NV (US)

(73) Assignee: DOG PACER LLC, Las Vegas, NV (US)

(21) Appl. No.: 13/651,374

(22) Filed: Oct. 12, 2012

Related U.S. Application Data
(60) Provisional application No. 61/546,162, filed on Oct. 12, 2011.

(51) Int. Cl. A01K 15/02

(52) U.S. Cl. 119/703

(57) ABSTRACT

An apparatus for a foldable treadmill for pets includes a front frame, a rear frame, at least two hinges, at least two stabilizing mechanisms, a belt, an overhead bar, and a pair of side panels. The front frame and the rear frame pivotally connected to each other by the at least two hinges, which allows the front frame and the rear frame to move in between a folded position and an unfolded position. The at least two stabilizing mechanisms linearly secures the front frame and the rear frame at the unfolded position. The belt is linearly positioned around the front frame and the rear frame where a motorized front roller and a back roller rotate the belt. The overhead bar and the pair of side panels create a restricted area so that pets can exercise on the rotating belt.

The current application claims a priority to the U.S. Provisional Patent application Ser. No. 61/546,162 filed on Oct. 12, 2011.

### FIELD OF THE INVENTION

The present invention relates generally to an apparatus for exercise. More specifically, the present invention is a treadmill device for pets, which can be folded in half for increased portability.

### BACKGROUND OF THE INVENTION

Pet treadmills are generally used to provide an exercise means for pets when the option of walking the pets is not available. It is well known among pet owners, especially dog owners that pets require more exercise each day, and also want to exercise more frequently than humans. Frequent and sufficient exercise can help the pet stay in good health. A problem which often occurs with pet owners is not having the time or the right environment to take their pet on frequent walks. Pet treadmills provide a solution to this problem by offering a machine for pets to obtain the necessary amount of exercise in a more convenient setting. However, a disadvantage of currently existing pet treadmills is that it can be large and cumbersome for storage or transportation during periods of non-use. It is therefore an object of the present invention to provide a new and improved pet treadmill exercising device which offers all the advantages of currently existing pet treadmill exercise machines without any of its disadvantages.

### BRIEF DESCRIPTION OF THE DRAWINGS

FIG. 1 is a perspective view of the present invention at an unfolded position.

FIG. 2 is a side perspective view of the present invention, where the present invention being transformed from a folded position to the unfolded position.

FIG. 3 is a side perspective view of the present invention, where the present invention being transformed from the unfolded position to the folded position.

FIG. 4 is a detail side view of hinges and stabilizing mechanisms at the partially folded position.

FIG. 5 is a detail bottom view of the hinge and the stabilizing mechanisms at the unfolded position.

FIG. 6 is a detail view of a control interface where the dash lines are illustrating a data storage unit, which is hidden within the control interface.

FIG. 7 is a side view of a front frame and the rear frame where the dash lines are illustrating a front roller and a back roller, which are hidden within the front frame and the rear frame.

FIG. 8 is a front perspective view showing the inside of a motor housing.

FIG. 9 is side view of the present invention illustrating the fully folded position.

FIG. 10 is a cross section view of a back end of the rear frame.

### DETAIL DESCRIPTIONS OF THE INVENTION

All illustrations of the drawings are for the purpose of describing selected versions of the present invention and are not intended to limit the scope of the present invention.

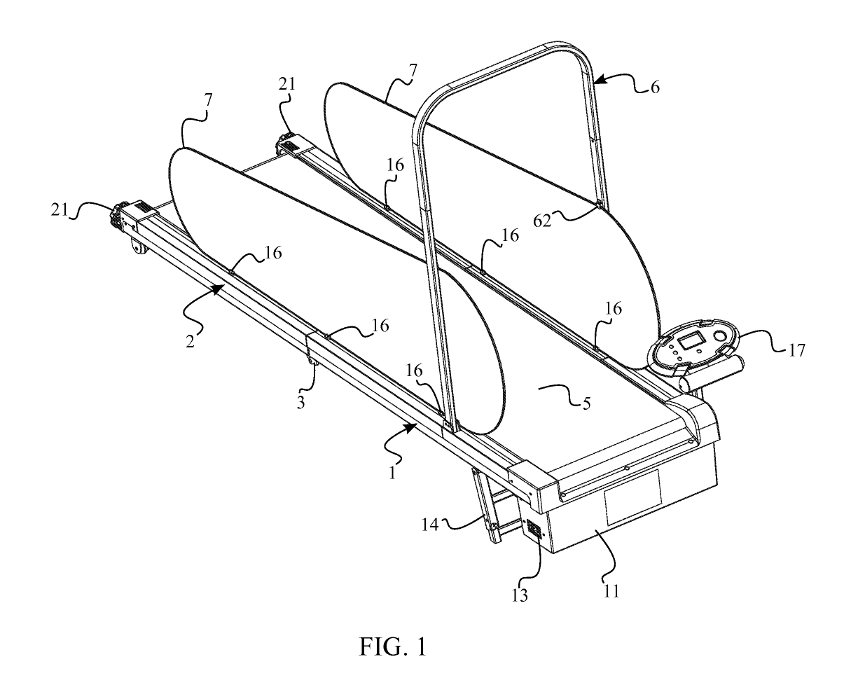

In reference to FIG. 1, the present invention is an apparatus for foldable treadmill where the present invention is used by pets. The present invention can be folded in half lengthwise where the length of the frame is longer than the width of the frame. The present invention comprises a front frame 1, a rear frame 2, at least two hinges 3, at least two stabilizing mechanisms 4, a belt 5, an overhead bar 6, and a pair of side panels 7.

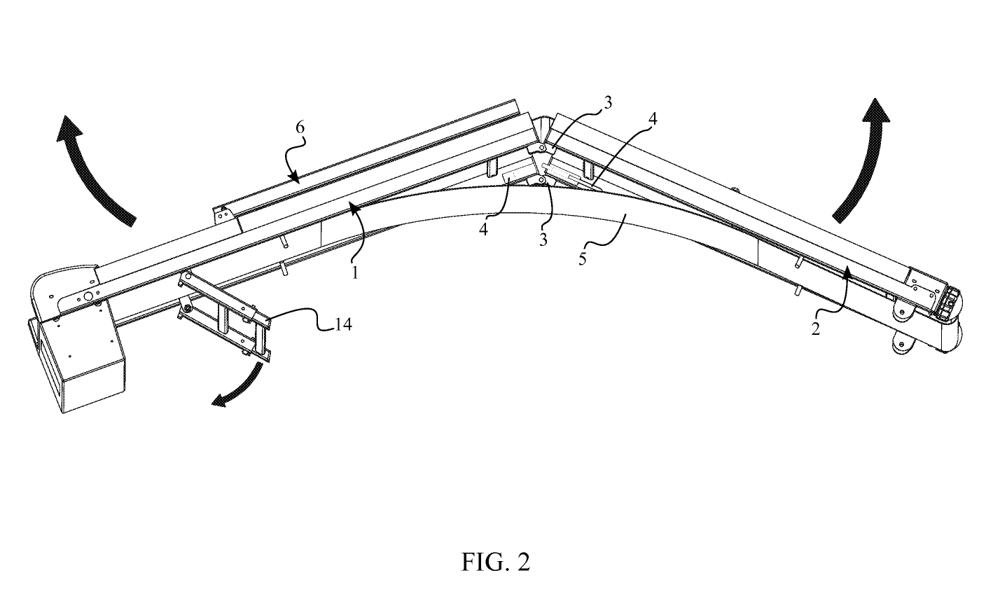

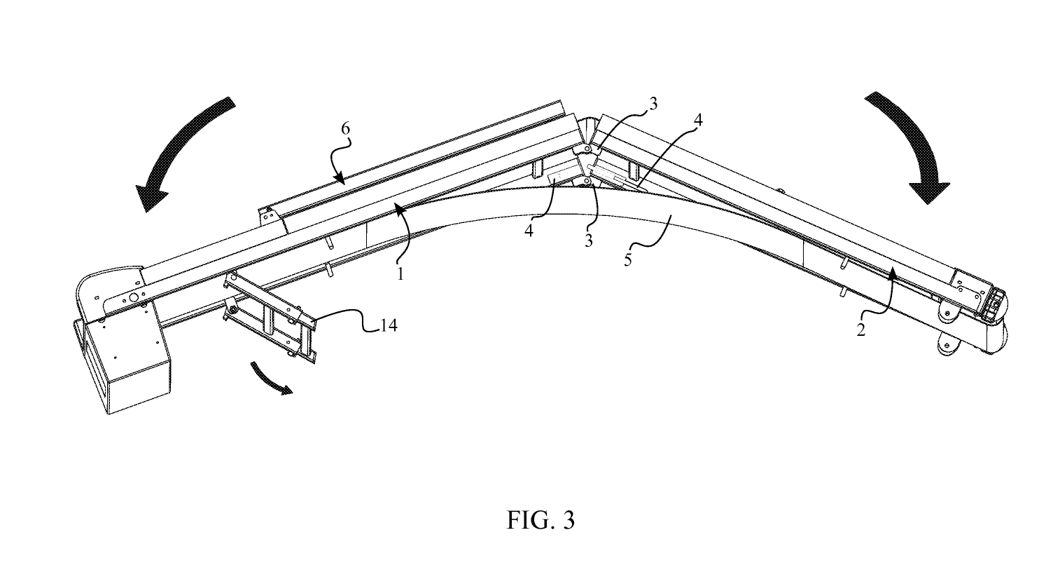

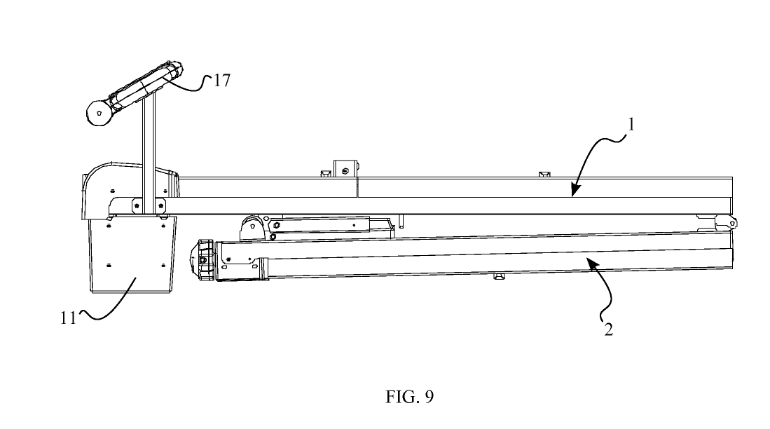

In reference to FIG. 2, FIG. 3, and FIG. 9, the front frame 1 and the rear frame 2 are linearly positioned atop the at least two hinges 3, and the at least two hinges 3 are positioned adjacent with a back end of the front frame 1 and a front end of the rear frame 2. The front frame 1 and the rear frame 2 are pivotally connected to each other by the at least two hinges 3. The at least two hinges 3 allows the front frame 1 and the rear frame 2 to move in between a folded position and an unfolded position. The at least two hinges 3 comprise a zero degree angle when the present invention is at the folded position, and the at least two hinges 3 comprise 180 degree angle when the present invention is at the unfolded position. The unfolded position of the present invention linearly aligns the front frame 1 and the rear frame 2. In connection to one another, the front frame 1 and the rear frame 2 serve as a single frame and provide a surface upon which the belt 5 can be implemented.

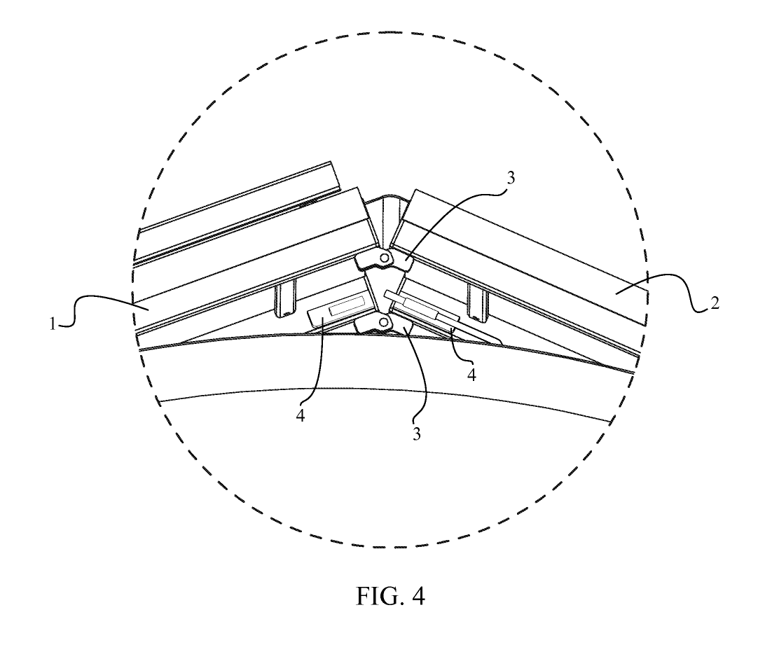

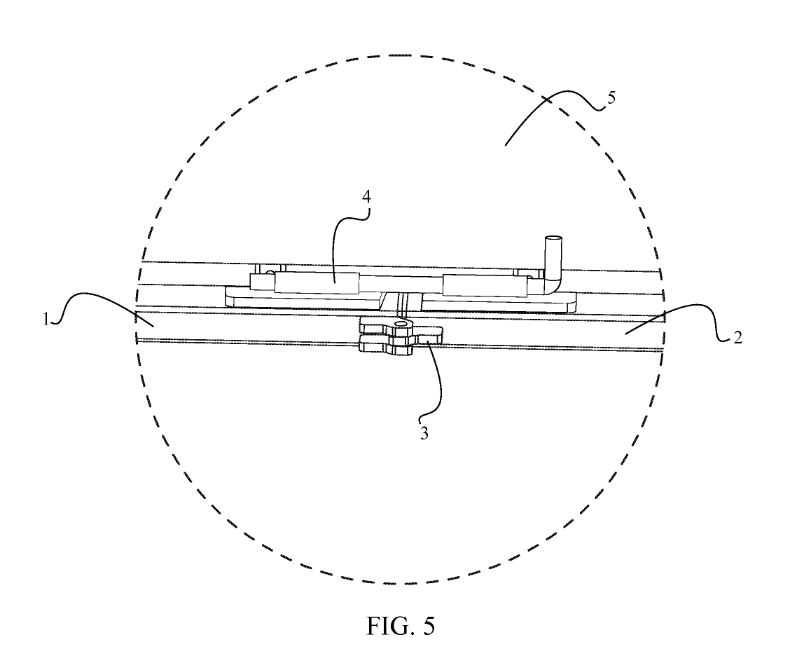

The at least two stabilizing mechanisms 4 of the present invention may include but is not limited to a slide bolt lock, a clamp lock, and a gasket such as the type typically used for glass kitchen canisters. In reference to FIG. 4 and FIG. 5, the front frame 1 and the rear frame 2 are securely attached to each other by the at least two stabilizing mechanisms 4 when the present invention is at the unfolded position. The at least two stabilizing mechanisms 4 is positioned at the inside edge of the front frame 1 and the rear frame 2 where the at least two stabilizing mechanisms 4 is hidden from outside for aesthetic appearance. For example, the present invention can use the clamp lock with a thumb pedal as the at least two stabilizing mechanisms 4. When the thumb pedal is depressed, the clamp lock secures the front frame 1 and the rear frame 2 together for stability. When the thumb pedal is uplifted, the clamp lock releases the front frame 1 from the rear frame 2 and allows the present invention to be folded in half about the at least two hinges 3. In the preferred embodiment of the present invention, the slide bolt lock is used as the at least two stabilizing mechanisms 4 to lock the front frame 1 and the rear frame 2 in linearly confluent relationship. The at least two stabilizing mechanisms 4 in the preferred embodiment comprises a stabilizing pin and a pair of locking channels. When the present invention is at the unfolded position, the stabilizing pin is inserted through the pair of locking channels so that the front frame 1 and the rear frame 2 can be secured together. When the stabilizing pin is pulled out from the pair of locking channels, the present invention can be converted into the folded position.

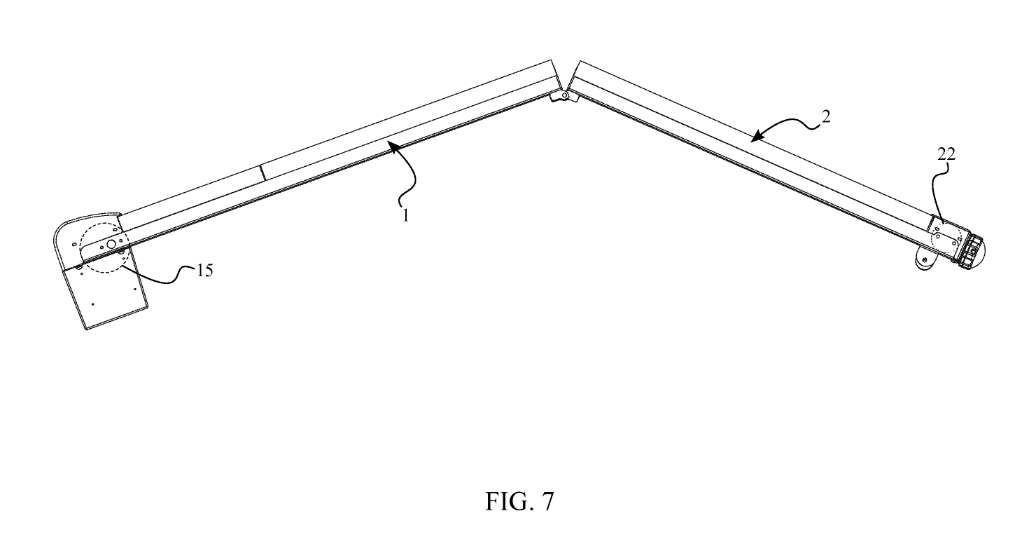

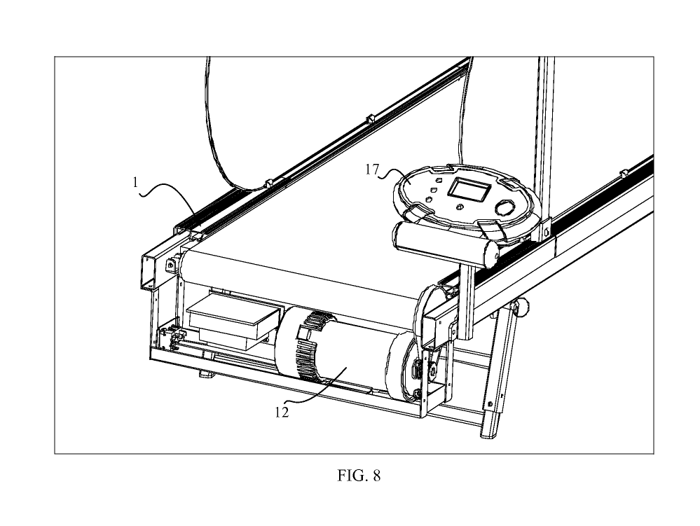

In reference to FIG. 1 and FIG. 7, In the preferred embodiment of the present invention, the front frame 1 is a rectangular shaped frame, where the front frame 1 comprises a motor housing 11, a motor 12, a power source 13, an inclined stand 14, a front roller 15, and a control interface 17. The front frame 1 of the present invention is not limited to the rectangular shaped frame and can be any other types of geometrical shapes. In reference to FIG. 8, the motor housing 11 is positioned below the front frame 1 and is positioned flush with a front end of the front frame 1. The motor housing 11 houses the motor 12 and other related components required for the functionality of the motor 12. The motor housing 11 keeps the motor 12 and the other related components away from the dusts and debris in order to optimize the efficiency and the longevity of the motor 12. The power source 13 is positioned on the motor housing 11 where the power source 13 electrically powered the motor 12. In the preferred embodiment of the present invention, the power source 13 is an alternating current where the alternating current is supplied from an alternating current outlet through an electrical power code. A female end of the electrical power code connects with a male end of the power source 13, and a male end of the electrical power code connects with a female socket on the alternating current outlet. Since the preferred embodiment of the present invention comprises the alternating current as the power source 13, the motor 12 and the other related components are chosen according to the alternating current for the proper functionality. A direct current may also use as the power source 13 of the present invention where the motor 12 and the other related components are chosen according to the direct current.

The inclined stand 14 is positioned adjacent with the motor housing 11 and comprises a rotatable section and an extension section. The extension section is inserted into the rotatable section where the extension section is able to extend out from the rotatable section. The rotatable section is rotatably connected to the front frame 1 opposite from the extension section. The extension section extends into a plurality of heights so that the present invention can be raised into different heights from the front end of the front frame 1. A spring loaded ball locking mechanism or any other type of simple locking mechanism is used to secure the rotatable section and the extension section together. The inclined stand 14 can be folded parallel with the front frame 1 when the present invention is at the folded position.

The front roller 15 is pivotally positioned with the front end of the front frame 1. The front roller 15 is also mechanically coupled with the motor 12. The front roller 15 and the motor 12 can be either directly connected or indirectly connected with gears, tension belts, chains, or any other types of connections. In the preferred embodiment of the present invention, the motor 12 is connected to the front roller 15 by a tension belt.

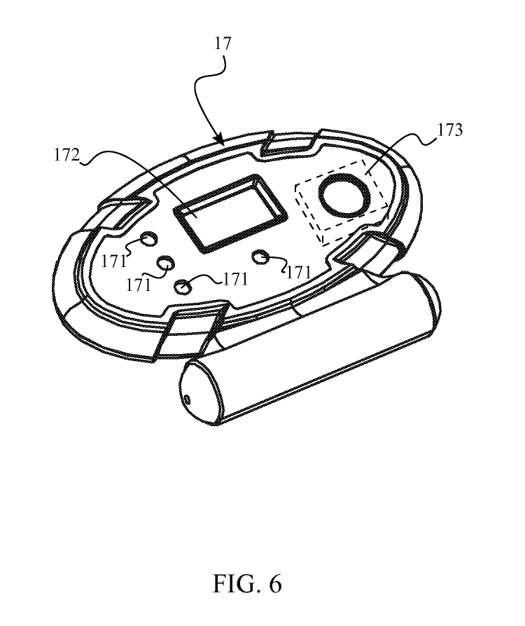

In reference to FIG. 1 and FIG. 6, the control interface 17 is rotatably connected to the front frame 1 and positioned above the front frame 1. When the present invention is at the folded position, the control interface 17 can also be linearly folded up against the front frame 1. The control interface 17 comprises a plurality of control buttons 171, a display panel 172, and a data storage unit 173. The plurality of control buttons 171 and the display panel 172 are positioned on the control interface 17, and the data storage unit 173 is positioned within the control interface 17. The plurality of control buttons 171 operates the functionality of the present invention and can include but is not limited to turning on/off the present invention, starting/stopping the present invention, speeding up/slowing down the present invention, etc. The display panel 172 of the control interface 17 can provide data such as but not limited to the current speed, distance ran, time elapsed, projected health information, and exercise information. The data storage unit 173 records multiple data, such as a predetermined number of exercises and related details, while the present invention is functioning. The multiple data can be accessed through the plurality of control buttons 171 and the display panel 172.

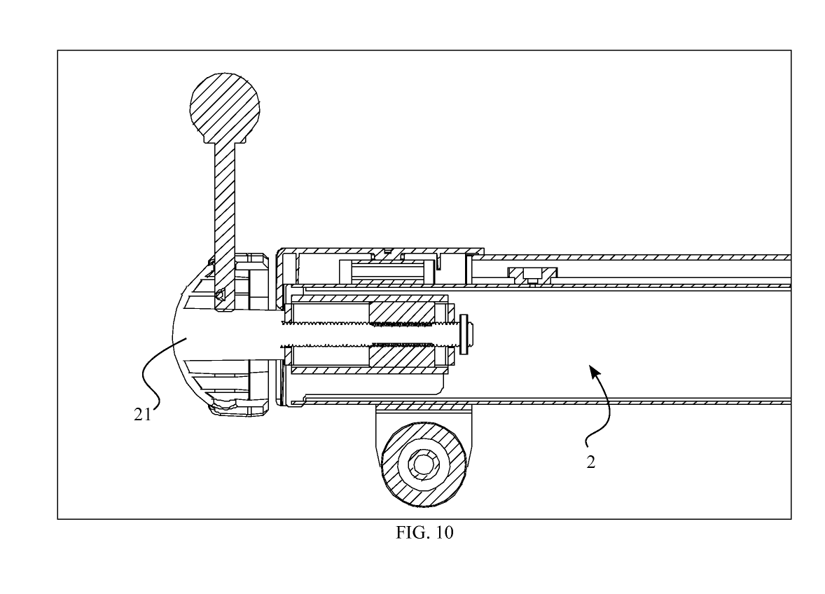

In reference to FIG. 1, FIG. 7, and FIG. 10, the rear frame 2 comprises tension adjustment dials 21 and a back roller 22. The back roller 22 is pivotally positioned with a back end of the rear frame 2. Each extremity of the back roller 22 is also mechanically coupled with each of the tension adjustment dials 21 where the tension adjustment dials 21 are linearly positioned with the back end of the rear frame 2. Each extremity of the back roller 22 comprises a connection cavity where the connection cavity is a threaded hole. Each of the tension adjustment dials 21 comprises a knob, a plurality of leverage holes, and a cylindrical section. The cylindrical section is traversed into the rear frame 2 where the cylindrical section is externally threaded. Once the cylindrical section is traversed, the externally threaded cylindrical section attaches with the threaded hole of the connection cavity. The knob is concentrically connected to the cylindrical section where the knob provides a surface area so that users of the present invention can easily twist the knob. The plurality of leverage holes is perimetrically positioned around the knob in order to insert a lever so that additional leverage can be gained when the knob is twisted from the lever. When the users simultaneously twist the knobs of the tension adjustment dials 21, the tension adjustment dials 21 relocate the positioning of the back roller 22. At least two wheels are connected to the back end of the rear frame 2, and the at least two wheels are perpendicularly positioned from the tension adjustment dials 21. The at least two wheels enables the users to easily move the present invention from one place to another.

The belt 5 is positioned and looped around the front roller 15 and the back roller 22. The belt 5 is single continuous loop so that the front roller 15 can rotate the belt 5 and the back roller 22 can support the rotations of the belt 5. Additional rollers may be connected to the front frame 1 and the rear frame 2 in between the front roller 15 and the back roller 22 in order to provide additional support to the belt 5. The belt 5 provides a running surface whereupon the pets can tread and exercise. The running surface is positioned on the exterior of the belt 5, encasing the front roller 15 and the back roller 22 therein in a taut manner so that, when the front roller 15 and the back roller 22 are turned during operation of the present invention, the running surface is forced to turn in the same direction. Since the positioning of the back roller 22 can be moved from the tension adjustment dials 21, the tension of the belt 5 can be easily adjusted by the tension adjustment dials 21, thereby smooth running surface can be obtained for the pets to exercise thereupon. The back end of the rear frame 2 comprises numbered gauges adjacent to the tension adjustment dials 21. The numbered gauges enable the users to properly and equally adjust the back roller 22 from each of the tension adjustment dials 21 so that the belt 5 can be smoothly rotated around the back roller 22 without creating any vibrations. The tension adjustment dials 21 also release the tension of the belt 5 so that the present invention can be easily converted into the folded position from the unfolded position without damaging the belt 5, the front roller 15, and the back roller 22.

In reference to FIG. 1, the overhead bar 6 comprises a pair of panel locking brackets 62. Each extremity of the overhead bar 6 is adjacently positioned with the front frame 1, and the overhead bar 6 is rotatably connected to the front frame 1. The overhead bar 6 can be rotated so that the height of the overhead bar 6 can lay linearly or perpendicularly with the front frame 1. When the present invention is at the unfolded position, the overhead bar 6 is perpendicularly positioned with the front frame 1 for the proper functionality. When the present invention is at the folded position, the overhead bar 6 is linearly positioned with the front frame 1 for compact storage purposes. The overhead bar 6 also functions as removable component so that the overhead bar can be removed from the present invention. In the preferred embodiment of the present invention, the pair of panel locking brackets 62 is L-shaped brackets, but the pair of panel locking brackets 62 is not limited to the L-shaped brackets and can be any other shaped, as long as the pair of panel locking brackets 62 supports the vertical positioning of the pair of side panels 7.

In reference to FIG. 1, the pair of side panels 7 is oppositely positioned from each other and adjacently positioned within the overhead bar 6. When the present invention is at the unfolded position, the pair of side panels 7 is vertically positioned with the front frame 1 and the rear frame 2, and a top edge of the pair of side panels 7 is inserted or attached to the pair of panel locking brackets 62. A bottom edge of the pair of side panels 7 is attached to the front frame 1 and the rear frame 2 by a plurality of panel locking mechanisms 16. The plurality of panel locking mechanisms 16 can include but is not limited to a snap locking system, a magnetic lock system, a mechanical lock system, a pin lock system, and any other lock systems. The pair of side panels 7 keeps the pets parallel with the belt 5 during the exercises and blocks all of the side exits while creating safe exercising environment for the pets. The pair of side panels 7 may be made out of flexible materials so that the pair of side panels 7 can be folded and stored away with less storage space.

The overhead bar 6 may additionally comprise a leash attachment, where the leash attachment enables the users to attach a leash of a pet. The leash attachment contains a pet within the confinements of the belt so that the pet can't deviate from the present invention during an exercise. The leash attachment can be a ring, a hock, or any other similar attachments. The leash attachment can be adjacently connected with the overhead bar 6 in between the pair of panel locking brackets 62.

Although the invention has been explained in relation to its preferred embodiment, it is to be understood that many other possible modifications and variations can be made without departing from the spirit and scope of the invention as hereinafter claimed.

What is claimed is:

1. An apparatus for a foldable treadmill for pets comprises,
a front frame;
a rear frame;
at least two hinges;
at least two stabilizing mechanisms;
a belt;
an overhead bar;
a pair of side panels;
the front frame comprises a motor housing, a motor, a power source, an inclined stand, a front roller, and a control interface;
the rear frame comprises tension adjustment dials and a back roller; and
the overhead bar comprises a pair of panel locking brackets.

2. The apparatus for a foldable treadmill for pets as claimed in claim 1 comprises,
the front frame being adjacently positioned with the rear frame;
the front frame and the rear frame being positioned atop the at least two hinges;
the front frame and the rear frame being pivotally connected to each other by the at least two hinges; and
the at least two stabilizing mechanisms being adjacently positioned with the at least two hinges.

3. The apparatus for a foldable treadmill for pets as claimed in claim 2 comprises,
the motor housing being oppositely positioned from the at least two hinges;
the front frame being connected atop the motor housing;
the inclined stand being positioned in between the motor housing and the at least two hinges;
the inclined stand being rotatably connected to the front frame;
the motor being positioned within the motor housing;
the power source being positioned on the motor housing;
the front roller being adjacently positioned with the motor housing;
the front roller being pivotally connected to the front frame; and
the front roller being mechanically coupled with the motor.

4. The apparatus for a foldable treadmill for pets as claimed in claim 2 comprises,
the tension adjustment dials being oppositely positioned from the at least two hinges;
the tension adjustment dials being linearly traversed into the rear frame;
the back roller being adjacently positioned with the tension adjustment dials;
the back roller being pivotally connected to the rear frame; and
the tension adjustment dials being mechanically coupled with the back roller.

5. The apparatus for a foldable treadmill for pets as claimed in claim 1 comprises,
the belt being positioned around the front roller and the back roller; and
the belt being securely looped around the front roller and the back roller.

6. The apparatus for a foldable treadmill for pets as claimed in claim 1 comprises,
the overhead bar being adjacently positioned with the front frame at each extremity;
the overhead bar being rotatably connected to the front frame; and
the pair of panel locking brackets being oppositely positioned on the overhead bar.

7. The apparatus for a foldable treadmill for pets as claimed in claim 1 comprises,
the pair of side panels being oppositely positioned from each other;
the pair of side panels being perpendicularly attached to the front frame and the rear frame by a plurality of panel locking mechanisms; and
the pair of side panels being positioned within the pair of panel locking brackets.

8. The apparatus for a foldable treadmill for pets as claimed in claim 1 comprises,
the control interface comprises a plurality of control buttons, a display panel, and a data storage unit;
the control interface being connected to the front frame;
the plurality of control buttons and the display panel being positioned on the control interface;
the data storage unit being positioned within the control interface; and
the plurality of control buttons, the display panel, the data storage unit, the motor, and the power source being electrically connected to each other.

9. An apparatus for a foldable treadmill for pets comprises,
a front frame;
a rear frame;
at least two hinges;
at least two stabilizing mechanisms;
a belt;
an overhead bar;
a pair of side panels;
the front frame comprises a motor housing, a motor, a power source, an inclined stand, a front roller, and a control interface;
the rear frame comprises tension adjustment dials and a back roller;
the overhead bar comprises a pair of panel locking brackets;
the front frame being adjacently positioned with the rear frame;
the front frame and the rear frame being positioned atop the at least two hinges;
the front frame and the rear frame being pivotally connected to each other by the at least two hinges; and
the at least two stabilizing mechanisms being adjacently positioned with the at least two hinges.

10. The apparatus for a foldable treadmill for pets as claimed in claim 9 comprises,
the motor housing being oppositely positioned from the at least two hinges;
the front frame being connected atop the motor housing;
the inclined stand being positioned in between the motor housing and the at least two hinges;
the inclined stand being rotatably connected to the front frame;
the motor being positioned within the motor housing;
the power source being positioned on the motor housing;
the front roller being adjacently positioned with the motor housing;
the front roller being pivotally connected to the front frame; and
the front roller being mechanically coupled with the motor.

11. The apparatus for a foldable treadmill for pets as claimed in claim 9 comprises,
the tension adjustment dials being oppositely positioned from the at least two hinges;
the tension adjustment dials being linearly traversed into the rear frame;
the back roller being adjacently positioned with the tension adjustment dials;
the back roller being pivotally connected to the rear frame; and
the tension adjustment dials being mechanically coupled with the back roller.

12. The apparatus for a foldable treadmill for pets as claimed in claim 9 comprises,
the belt being positioned around the front roller and the back roller; and
the belt being securely looped around the front roller and the back roller.

13. The apparatus for a foldable treadmill for pets as claimed in claim 9 comprises,
the overhead bar being adjacently positioned with the front frame at each extremity;
the overhead bar being rotatably connected to the front frame; and
the pair of panel locking brackets being oppositely positioned on the overhead bar.

14. The apparatus for a foldable treadmill for pets as claimed in claim 9 comprises,
the pair of side panels being oppositely positioned from each other;
the pair of side panels being perpendicularly attached to the front frame and the rear frame by a plurality of panel locking mechanisms; and
the pair of side panels being positioned within the pair of panel locking brackets.

15. The apparatus for a foldable treadmill for pets as claimed in claim 9 comprises,
the control interface comprises a plurality of control buttons, a display panel, and a data storage unit;
the control interface being connected to the front frame;
the plurality of control buttons and the display panel being positioned on the control interface;
the data storage unit being positioned within the control interface; and
the plurality of control buttons, the display panel, the data storage unit, the motor, and the power source being electrically connected to each other.

16. An apparatus for a foldable treadmill for pets comprises,
a front frame;
a rear frame;
at least two hinges;
at least two stabilizing mechanisms;
a belt;
an overhead bar;
a pair of side panels;
the front frame comprises a motor housing, a motor, a power source, an inclined stand, a front roller, and a control interface;
the rear frame comprises tension adjustment dials and a back roller;
the overhead bar comprises a pair of panel locking brackets;
the front frame being adjacently positioned with the rear frame;
the front frame and the rear frame being positioned atop the at least two hinges;
the front frame and the rear frame being pivotally connected to each other by the at least two hinges;
the at least two stabilizing mechanisms being adjacently positioned with the at least two hinges;
the front roller being adjacently positioned with the motor housing;
the back roller being adjacently positioned with the tension adjustment dials;
the belt being positioned around the front roller and the back roller; and
the belt being securely looped around the front roller and the back roller;

17. The apparatus for a foldable treadmill for pets as claimed in claim 16 comprises,
the motor housing being oppositely positioned from the at least two hinges;
the front frame being connected atop the motor housing;
the inclined stand being positioned in between the motor housing and the at least two hinges;
the inclined stand being rotatably connected to the front frame;
the motor being positioned within the motor housing;
the power source being positioned on the motor housing;
the front roller being pivotally connected to the front frame; and
the front roller being mechanically coupled with the motor.

18. The apparatus for a foldable treadmill for pets as claimed in claim 16 comprises,
the tension adjustment dials being oppositely positioned from the at least two hinges;
the tension adjustment dials being linearly traversed into the rear frame;
the back roller being pivotally connected to the rear frame; and
the tension adjustment dials being mechanically coupled with the back roller.

19. The apparatus for a foldable treadmill for pets as claimed in claim 16 comprises,
the overhead bar being adjacently positioned with the front frame at each extremity;
the overhead bar being rotatably connected to the front frame;
the pair of panel locking brackets being oppositely positioned on the overhead bar;
the pair of side panels being positioned within the pair of panel locking brackets;
the pair of side panels being oppositely positioned from each other; and
the pair of side panels being perpendicularly attached to the front frame and the rear frame by a plurality of panel locking mechanisms.

20. The apparatus for a foldable treadmill for pets as claimed in claim 16 comprises,
the control interface comprises a plurality of control buttons, a display panel, and a data storage unit;
the control interface being connected to the front frame;
the plurality of control buttons and the display panel being positioned on the control interface;
the data storage unit being positioned within the control interface; and
the plurality of control buttons, the display panel, the data storage unit, the motor, and the power source being electrically connected to each other.
